(19) United States
(12) Patent Application Publication
(10) Pub. No.: US 2024/0336993 A1
(43) Pub. Date: Oct. 10, 2024

(54) METHOD FOR PREPARING HIGH-PURITY METALLIC ARSENIC FROM ARSENIC-CONTAINING SOLID WASTE THROUGH SHORT FLOW PROCESS

(71) Applicant: CENTRAL SOUTH UNIVERSITY, Changsha (CN)

(72) Inventors: Wei SUN, Changsha (CN); Haisheng HAN, Changsha (CN); Jia TIAN, Changsha (CN); Jun PENG, Changsha (CN); Yufeng WANG, Changsha (CN); Xingfei ZHANG, Changsha (CN); Wenjihao HU, Changsha (CN); Yuehua HU, Changsha (CN)

(73) Assignee: CENTRAL SOUTH UNIVERSITY, Changsha (CN)

(21) Appl. No.: 18/027,934

(22) PCT Filed: Oct. 19, 2022
(86) PCT No.: PCT/CN2022/126068

§ 371 Date: Mar. 23, 2023

(30) Foreign Application Priority Data
Mar. 25, 2022 (CN) 202210299826.7

(51) Int. Cl. C22B 30/04; C22B 1/02; C22B 5/10; C22B 7/00

(52) U.S. Cl. CPC C22B 30/04; C22B 1/02; C22B 5/10; C22B 7/001; C22B 7/008

(57) ABSTRACT

A method for preparing high-purity metallic arsenic from arsenic-containing solid waste through a short flow process is provided. The method includes: performing oxidative alkaline leaching on nonferrous metallurgy arsenic-containing solid waste to obtain an arsenic-containing alkaline leaching solution; sequentially adding a mixed ammonium magnesium reagent consisting of a carboxyl and/or hydroxy-containing water-soluble macromolecular organic matter, a magnesium compound and an ammonium compound, and a hydrophobic macromolecular organic matter having a periodic geometric structure into the arsenic-containing alkaline leaching solution, and taking a reaction under stirring to obtain complex arsenate crystals cladded with an organic matter; and roasting the complex arsenate crystals cladded with the organic matter, then mixing the roasted complex arsenate crystals cladded with the organic matter with carbon powder, performing reduction roasting, and recycling metallic arsenic from smoke through condensation.

### CROSS REFERENCE TO THE RELATED APPLICATIONS

This application is the national phase entry of International Application No. PCT/CN2022/126068, filed on Oct. 19, 2022, which is based upon and claims priority to Chinese Patent Application No. 202210299826.7, filed on Mar. 25, 2022, the entire contents of which are incorporated herein by reference.

### TECHNICAL FIELD

The present invention relates to a method for resource utilization of nonferrous metallurgy arsenic-containing solid waste, more particularly relates to a method for preparing high-purity metallic arsenic from arsenic-containing solid waste, and is applicable to the technical fields of harmless disposal and resource utilization of nonferrous metallurgy arsenic-containing solid waste.

### BACKGROUND

In traditional cognition, arsenic causes serious environmental pollution and threatens human life and health. People often turn pale at the mere mention of arsenic. However, arsenic is a kind of amphoteric element with special physical and chemical properties, is a core raw material of semiconductor materials, and is widely used in strategic emerging industries such as chips, electronic information, biological medicine, photovoltaic, military, aerospace and the like. The application of high-end arsenic products with high-purity arsenic as raw materials to various fields such as new materials, electronic information, biological medicine and high-end equipment manufacturing is rapidly replacing the application of low-end arsenic products with arsenic trioxide as raw materials to the fields of pesticides, corrosion prevention, glass, ceramics and the like, and the global demand continues to increase.

Arsenic is mostly from the mining, mineral dressing and smelting operations of paragenic and associated arsenic metal ores, and mainly exists in a form of smelting by-products in arsenic-containing solid wastes such as flue dust, arsenic alkali slag, anode slime, arsenic sulfide slag and arsenic matte, has the characteristics of high arsenic content, complex components and high treatment difficulty, and greatly threatens the surrounding environment. In fact, these solid wastes contain much more arsenic than traditional arsenic ores (Realgar ores), and have the potential to prepare arsenic products.

### SUMMARY

### Technical problem

In a traditional process, the arsenic-containing solid waste is treated by a fire roasting method, and white arsenic by-products are recovered. Then, the white arsenic products are further used for preparing high-purity arsenic. However, some impurity components such as antimony and selenium, which have similar properties to arsenic, are inevitably contained in the white arsenic products produced by the fire roasting method, so that repeated purification is required during high-purity arsenic production by using the white arsenic products as raw materials, the flow process is complicated, the operation difficulty is high and the cost is high. In Chinese patent (CN101935767B), in order to remove impurities in arsenic trioxide to prepare high-purity arsenic, a method combining multiple sublimation distillation with hydrogen reduction is used, but the operation is very complicated. At present, there are some researches devote to the development of technologies to recover elemental arsenic from arsenic-containing solid wastes, but the researches focus on improving the recovery rate of elemental arsenic, and do not pay attention to the quality of elemental arsenic. For example, Chinese patent (CN1068936864A) provides a method of recovering arsenic from black copper sludge. According to this technology, firstly, an arsenic component in a black copper sludge alkaline leaching solution is firstly precipitated through lime, then the arsenic component in arsenic calcium slag is recovered through reduction roasting, and the span from arsenic-containing solid wastes to elemental arsenic is realized. However, the arsenic content of the prepared arsenic product is only higher than 95%, and a complicated purification and impurity removal work procedure is still required for subsequent preparation of high-purity arsenic from the elemental arsenic. Based on the above, developing a technology for deeply separating arsenic from similar impurities such as antimony, selenium and bismuth to prepare high-purity metallic arsenic raw materials is a key point for high-purity arsenic production. Chinese patent (CN108611494A) provides a method for efficient and comprehensive resource utilization of arsenic alkali slag. According to this method, the efficient separation problem of arsenic from alkali in an alkaline leaching solution is solved through complex arsenate crystallization and precipitation, and an effect of resource recycling of alkali components is achieved. In subsequent studies, it is discovered that the separation of arsenic from alkali is ensured through high selectivity in the complex arsenate crystallization process, at the same time, primary separation of arsenic from impurity components (antimony, selenium, aluminum and the like) in the leaching solution is also realized, and possibility is provided for the purification of arsenic. However, in the complex arsenate crystallization process under conventional conditions, a small amount of impurity ions can still be doped in complex arsenate crystals in a manner of adsorption or cladding, and the deep purification of arsenic and impurities cannot be realized. Therefore, if the regulation and control on the complex arsenate crystallization process is enhanced and the impurity doping in the crystals is reduced to prepare high-purity complex arsenate, the high-purity metallic arsenic product can be prepared by utilizing the complex arsenate.

### Technical Solution

By aiming at the problems of separation difficulty of arsenic from similar impurities in high-purity arsenic preparation process from arsenic-containing solid waste in the prior art, the present invention aims at providing a method for preparing high-purity metallic arsenic from nonferrous metallurgy arsenic-containing solid waste through a short flow process. According to the method, an organic-inorganic interface matching synergistic effect generated by a carboxyl and/or hydroxy-containing water-soluble macromolecular organic matter and a hydrophobic macromolecular organic matter having a periodic geometric structure in a reaction system is used for regulating and controlling the mineralized crystallization process of complex arsenate. Through high-precision mineralized crystallization of complex arsenate, deep separation of arsenic from various impurities such as antimony, selenium and bismuth in the arsenic-containing solid waste alkaline leaching solution is realized, and the high-purity arsenic is obtained through reduction roasting on this basis. In addition, the method has the advantages of high speed, high efficiency, low cost, simple process and operation convenience, and can achieve industrial production.

In order to achieve the above technical purpose, the present invention provides a method for preparing high-purity metallic arsenic from arsenic-containing solid waste through a short flow process. The method includes the following steps:
1) performing oxidative alkaline leaching on nonferrous metallurgy arsenic-containing solid waste to obtain an arsenic-containing alkaline leaching solution;
2) sequentially adding a mixed ammonium magnesium reagent consisting of a carboxyl and/or hydroxy-containing water-soluble macromolecular organic matter, a magnesium compound and an ammonium compound, and a hydrophobic macromolecular organic matter having a periodic geometric structure into the arsenic-containing alkaline leaching solution, and taking a reaction under stirring to obtain complex arsenate crystals cladded with an organic matter; and
3) roasting the complex arsenate crystals cladded with the organic matter, then mixing the roasted complex arsenate crystals cladded with the organic matter with carbon powder, performing reduction roasting, and recycling metallic arsenic from smoke through condensation.

It is reported that in the prior art, an arsenic precipitation process of the arsenic-containing alkaline leaching solution is realized by using the ammonium magnesium reagent, however, a small amount of impurity ions can still be doped in complex arsenate crystals in a manner of adsorption or cladding in the crystallization process of the complex arsenate, and the deep purification of arsenic and impurities cannot be realized, so that high-purity arsenic cannot be further obtained in a subsequent process. The technical solution of the present invention is characterized in that the arsenic precipitation effect of the ammonium magnesium reagent is modified in a cooperative manner by using the carboxyl and/or hydroxy-containing water-soluble macromolecular organic matter and the hydrophobic macromolecular organic matter with high complexing capability to metal ions at the same time, by regulating and controlling the crystallization process of complex arsenate, doping of impurities in crystals can be reduced, and high-purity complex arsenate can be obtained, so that a high-purity arsenic product can be obtained. In an arsenic precipitation process with the ammonium magnesium reagent, the periodic geometric structure of the organic matter and the complex arsenate crystal structure are matched, and the complex arsenate crystals can be induced to precisely nucleate on the surfaces. At the same time, the nucleation speed, quantity, nucleate site and crystal form orientation of complex arsenate crystallization can be controlled through the interface interaction between functional groups contained in the organic matter and ions in the solution, the high selectivity of the complex arsenate crystallization process is further ensured, and the possibility is created for the deep separation of arsenic from impurities. For another example, the periodic geometric structure of chitosan molecules is matched with the complex arsenate crystal structure, the complex arsenate crystals can be induced to precisely nucleate on the surfaces. After the nucleation of the complex arsenate, carboxyl functional groups (—COO⁻) at two sides of a main chain of a sodium polyacrylate molecule can generate electrostatic interaction with cations Mg²⁺ in the complex arsenate crystal nucleuses, so as to be adsorbed onto the crystal surfaces, the surface energy of the crystals is reduced, the growth process of the complex arsenate crystals is controlled, so that the high-precision mineralized crystallization of the complex arsenate is realized. By introducing two kinds of organic matters, the complex arsenate almost containing no impurity components, such as antimony, selenium and tellurium, having the similar properties to arsenic can be generated, and the subsequent process of preparing high-purity arsenic from the metallic arsenic will be greatly simplified. The method is favorable for solving the bottleneck problem of lack of high-quality raw materials in the high-purity arsenic production process and promoting the sustainable development of the nonferrous metallurgy industry and strategic emerging industries.

As a preferable solution, the nonferrous metallurgy arsenic-containing solid waste includes at least one of arsenic alkali slag, copper smelting dust and lead anode slime. The nonferrous metallurgy arsenic-containing solid waste is common arsenic-containing metallurgy solid waste in the prior art.

As a preferable solution, the oxidative alkaline leaching is performed under the following conditions: hydrogen peroxide and/or ozone are/is used as an oxidizing agent, sodium hydroxide and/or sodium carbonate are/is used as an alkaline leaching medium, a leaching temperature is 50 to 90° C., a stirring speed is 200 to 700 rpm, and a leaching time is 1 to 3 h; the nonferrous metallurgy arsenic-containing solid waste is ground until a particle size is smaller than or equal to 1 mm; a concentration of the alkaline leaching medium is 0 to 4 mol/L; and a liquid-solid ratio is 4 to 10 mL/g. Under a preferable condition, the characteristic that the arsenate is soluble in alkali liquor, but most metal components are insoluble in alkali liquor is utilized to achieve the selective separation of an arsenic component from most metal components. A specific leaching process is as follows: after being ground, the nonferrous metallurgy arsenic-containing solid waste is mixed with water, and then, an oxidizing agent and alkali are added. In order not to introduce impurities, the oxidizing agent is preferably hydrogen peroxide or ozone, and a usage amount of the oxidizing agent is 1.5 to 2.0 times of a theoretical dosage of an oxidizing agent required for oxidizing trivalent arsenic in the nonferrous metallurgy arsenic-containing solid waste into pentavalent arsenic.

As a preferable solution, in the mixed ammonium magnesium reagent, a mole ratio of the magnesium compound to the ammonium compound is n (Mg/N)=0.2-1.0, and a ratio of the mass of the carboxyl and/or hydroxy-containing water-soluble macromolecular organic matter to the total mass of the magnesium compound and the ammonium compound is 1 to 10 mg/g. The mixed ammonium magnesium reagent is obtained through taking an anticipatory reaction on the magnesium compound, the ammonium compound and the carboxyl and/or hydroxy-containing water-soluble macromolecular organic matter: preparing a water solution with a concentration of 1 to 5 g/L from the carboxyl and/or hydroxy-containing water-soluble macromolecular organic matter, and then adding the magnesium compound and the ammonium compound according to a required proportion.

As a preferable solution, the carboxyl and/or hydroxy-containing water-soluble macromolecular organic matter is sodium polyacrylate and/or polyethylene glycol. Preferably, the carboxyl and/or hydroxy-containing water-soluble macromolecular organic matter can be mainly adsorbed onto surfaces of crystals through coordination, the interface energy of the crystals is reduced, and the growth process of the complex arsenate crystals is controlled, so that the high-precision mineralized crystallization of the complex arsenate is achieved.

As a preferable solution, the magnesium compound is at least one of magnesium oxide, magnesium chloride and magnesium sulfate.

As a preferable solution, the ammonium compound is at least one of ammonium hydrogen carbonate, ammonium chloride and ammonium sulfate. The magnesium compound and the ammonium compound are common magnesium salt and ammonium salt, which can be converted into an ammonium magnesium arsenate precipitate of a stable chemical structure with arsenate.

As a preferable solution, an adding concentration of the hydrophobic macromolecular organic matter having a periodic geometric structure in the arsenic-containing alkaline leaching solution is 1 to 5 g/L. The hydrophobic macromolecular organic matter having a periodic geometric structure is generally added after being prepared into a solution form, and is dispersed or dissolved into a water solution through effects of heating, ultrasonic treatment and the like. Specifically, for example, the hydrophobic macromolecular organic matter having a periodic geometric structure is mixed with 100° C. hot water according to 10 to 20 mL/g, and an ultrasonic treatment time is 30 to 50 min.

As a preferable solution, the adding amount of the mixed ammonium magnesium reagent in the arsenic-containing alkaline leaching solution is metered by a mole ratio of magnesium to arsenic of n(Mg/As)=1.2-2.5.

As a preferable solution, the hydrophobic macromolecular organic matter having a periodic geometric structure is polyvinyl alcohol and/or chitosan. Preferably, the organic matter having a periodic geometric structure is mainly used for inducing crystal nucleus generation.

As a preferable solution, the reaction under stirring is taken under the following conditions: a temperature is 30 to 50° C., a stirring speed is 300 to 500 rpm, and a time is 1 to 3 h. Under a preferable condition of reaction under stirring, a fast settling process of the magnesium ammonium arsenate precipitate can be controlled.

As a preferable solution, the roasting is performed under the following conditions: a temperature is 200 to 300° C., and a time is 2 to 3 h. Under a preferable roasting condition, crystal water and free ammonia components in the magnesium ammonium arsenate precipitate can be volatilized, and the treatment amount of reduction roasting is reduced.

As a preferable solution, the reduction roasting is performed under the following conditions: in an inert atmosphere, a roasting temperature is 800 to 1200° C., and a time is 2 to 4 h; and a dosage of the carbon powder is 10% to 15% of the mass of roasted slag. The inert atmosphere is nitrogen gas, argon gas and the like. In a preferable reduction roasting process, an efficient reduction and volatilization process of arsenic can be controlled.

The high-purity metallic arsenic prepared through the solution of the present invention refers to a high-purity metallic arsenic raw material with the purity not lower than 99%. 5 N-7 N metallic arsenic can be further obtained from the high-purity metallic arsenic with the purity not lower than 99% through an existing conventional vacuum distillation process. More particularly, the 99% high-purity metallic arsenic (i.e., 2 N metallic arsenic) is placed into a vacuum tank, argon gas is introduced into the vacuum tank through a gas inlet to eliminate air, the vacuum tank is heated to 610 to 650° C. to form arsenic steam, and then, hydrogen gas is introduced from the gas inlet to form mixed gas. A gas outlet is connected with a quartz reaction pipeline, and the arsenic steam is condensed at an inner wall of the quartz pipeline to form high-purity arsenic with the purity of 5 N to 7 N.

### Beneficial Effects

In order to solve the technical problems that in the prior art, there are still a small amount of impurity ions doped in complex arsenate crystals in a manner of adsorption or cladding in the arsenic precipitation process of the arsenic-containing alkaline leaching solution by using the ammonium magnesium reagent, the deep purification of arsenic from impurities cannot be realized, so that high-purity arsenic cannot be further obtained in a subsequent process, the technical solution of the present invention is characterized in that the arsenic precipitation effect of the ammonium magnesium reagent is modified in a cooperative manner by using the carboxyl and/or hydroxy-containing water-soluble macromolecular organic matter and the hydrophobic macromolecular organic matter having a periodic geometric structure at the same time, and an organic-inorganic interface matching synergistic effect generated by the carboxyl and/or hydroxy-containing water-soluble organic matter and the organic matter having a periodic geometric structure in a reaction system is used for regulating and controlling the mineralized crystallization process of complex arsenate. Through high-precision mineralized crystallization of complex arsenate, deep separation of arsenic from various impurities such as antimony, selenium and bismuth in the arsenic-containing solid waste alkaline leaching solution is realized, and the high-purity arsenic raw material is obtained through reduction roasting on this basis. In addition, the method has the advantages of high speed, high efficiency, low cost, simple process and operation convenience, and can achieve industrial production.

### DETAILED DESCRIPTION OF THE EMBODIMENTS

The following embodiments aim at further illustrating the contents of the present invention, but are not intended to limit the protection scope of claims of the present invention.

### Embodiment 1

5 kg of arsenic alkali slag (main components were As: 4.29%, Sb: 1.62%, Al: 2.41%, Fe: 0.89%, and alkali (mainly sodium carbonate): 54.71%) was taken to be mixed with 20 L of water. The arsenic alkali slag contained alkali, so only a proper amount of hydrogen peroxide needed to be supplemented in a leaching process, and the supplementation of sodium hydroxide or sodium carbonate was not needed. A leaching temperature was controlled to be 50° C. A stirring intensity was 500 rpm. A leaching time was 1.5 h. After the leaching was completed, solid-liquid separation was performed to obtain an arsenic-containing alkaline leaching solution. The main components were as shown in Table 1. An arsenic leaching rate was 92.15%.

After magnesium oxide and ammonium hydrogen carbonate were mixed according to a mole ratio of n(Mg/N)=0.5, sodium polyacrylate and the mixed reagent were mixed according to a mass ratio of 5 mg/g to prepare a mixed ammonium magnesium reagent. Chitosan and 100° C. hot water were mixed according to 15 mL/g, ultrasonic treatment was performed for 50 min, and sufficient dispersion was performed. Then, the mixed ammonium magnesium reagent and the chitosan solution were sequentially added into the alkaline leaching solution according to n(Mg/As)=1.5:1 and a concentration of 5 g/L, and sufficient stirring was performed at a temperature of 50° C. and a speed of 500 rpm for 3 h, filtration was performed after the reaction was completed, and complex arsenate crystals cladded with an organic matter were obtained.

The complex arsenate crystals were roasted for 3 h at a high temperature of 300° C., then the roasted slag and carbon powder were uniformly mixed (the mass of the carbon powder was 15% of the mass of the roasted slag), and were then placed into a tube furnace to be heated to 900° C. in a nitrogen gas atmosphere and maintained for 3 h. A metallic arsenic product was recycled at a condensing pipe section. Through detection, the purity of the metallic arsenic reached 99.84%, and contents of impurities such as antimony, selenium and aluminum were all lower than 0.01%.

TABLE 1
Chemical components of product in each work procedure

| | As | Sb | Al | Si | Se | Fe | Mg |
|---|---|---|---|---|---|---|---|
| Leaching solution | 9.81 | 0.12 | 0.86 | 0.37 | 0.29 | 0.05 | — |
| (g/L) | | | | | | | |
| Complex arsenate | 34.45 | <0.1 | — | — | <0.1 | — | 10.24 |
| (%) | | | | | | | |
| Metallic arsenic | 99.84 | <0.01 | <0.01 | — | <0.01 | — | <0.01 |
| (%) | | | | | | | |

Further, the obtained 99.84% metallic arsenic product was placed into a vacuum tank, argon gas was introduced into the vacuum tank through a gas inlet to eliminate air, the vacuum tank was heated to 610° C. to form arsenic steam, and then, hydrogen gas was introduced from the gas inlet to form mixed gas. A gas outlet was connected with a quartz reaction pipeline, and the arsenic steam was condensed at an inner wall of the quartz pipeline to form higher-purity arsenic with the purity of 6 N.

### Comparative Example 1

5 kg of arsenic alkali slag was taken to be mixed with 15 L of water. A leaching temperature was controlled to be 40° C. A stirring intensity was 500 rpm. A leaching time was 1.5 h. After the leaching was completed, solid-liquid separation was performed to obtain an arsenic-containing alkaline leaching solution. An arsenic leaching rate was 85.32%.

### Comparative Example 2

An alkaline leaching solution was prepared according to experiment parameters in Embodiment 1. Chitosan was not added in a preparation process of complex arsenate crystals. Other conditions were the same as those in Embodiment 1. Reaction parameters of a reduction roasting process of complex arsenate were the same as those in Embodiment 1. Finally, the purity of a metallic arsenic product was 97.89%, a content of impurity selenium was 0.05%, and a content of impurity antimony was 0.1%.

### Comparative Example 3

An alkaline leaching solution was prepared according to experiment parameters in Embodiment 1. Sodium polyacrylate was not added into a solution for preparing the mixed ammonium magnesium reagent in a preparation process of complex arsenate crystals. Other conditions were the same as those in Embodiment 1. Reaction parameters of a reduction roasting process of complex arsenate were the same as those in Embodiment 1. Finally, the purity of a metallic arsenic product was 96.98%, a content of impurity selenium was 0.09%, and a content of impurity antimony was 0.15%.

### Comparative Example 4

The process reaction parameters of arsenic alkali slag leaching and complex arsenate crystallization were controlled according to Embodiment 1. In the reduction roasting process, the mass of the carbon powder was 8% of the mass of roasted slag, and other conditions were the same as those in Embodiment 1. Finally, the purity of a metallic arsenic product was 81.55%, an oxygen content reached 15.31%, and contents of impurities such as antimony, selenium and aluminum were all lower than 0.01%.

### Comparative Example 5

An alkaline leaching solution was prepared according to experiment parameters in Embodiment 1. Sufficient lime was added into the leaching solution according to n(Ca/As)=3.0. Causticization was performed under the conditions of a temperature of 80° C., a time of 1 h and a stirring speed of 300 rpm, and solid-liquid separation was performed after the causticization was completed. A great amount of calcium carbonate and arsenic calcium slag were coprecipitated, a content of arsenic in arsenic slag was only 8.49%, and a precipitation rate of arsenic was only 67.44%.

### Embodiment 2

5 kg of lead anode slime (specific components were Pb: 12.88%, As: 27.53%, Sb: 24.92%, and Ag: 5.08%, As mainly existed in a form of elementary substance and oxidation state) was taken to perform oxidative alkaline leaching. In the leaching process, a proper amount of hydrogen peroxide was added to be used as an oxidizing agent, a liquid-solid ratio was controlled to be 10:1, a dosage of sodium carbonate and a dosage of sodium hydroxide were respectively 1 mol/L, a temperature was 60° C., a leaching time was 2 h, and a stirring speed was 500 rpm. After the leaching was completed, solid-liquid separation was performed to obtain an arsenic-containing alkaline leaching solution. The main components were as shown in Table 2. An arsenic leaching rate was 90.47%.

After magnesium chloride and ammonium chloride were mixed according to a mole ratio of n(Mg/N)=0.4, polyethylene glycol and the mixed reagent were mixed according to a mass ratio of 8 mg/g to prepare a mixed ammonium magnesium reagent. Polyvinyl alcohol and 100° C. hot water were mixed according to 18 mL/g, ultrasonic treatment was performed for 50 min, and sufficient dispersion was performed. The mixed ammonium magnesium reagent and the polyvinyl alcohol solution were sequentially added into the alkaline leaching solution according to n(Mg/As)=2.0:1 and a concentration of 5 g/L, and sufficient stirring was performed at a temperature of 50° C. and a speed of 500 rpm for 3 h, filtration was performed after the reaction was completed, and complex arsenate crystals cladded with an organic matter were obtained.

The complex arsenate crystals were roasted for 3 h at a high temperature of 250° C., then the roasted slag and carbon powder were uniformly mixed (the mass of the carbon powder was 12% of the mass of the roasted slag), and were then placed into a tube furnace to be heated to 1100° C. in a nitrogen gas atmosphere and maintained for 3 h. A metallic arsenic product was recycled at a condensing pipe section. Through detection, the purity of the metallic arsenic reached 99.89%, and contents of impurities such as lead, antimony and silver were all lower than 0.01%.

TABLE 2
Chemical components of product in each work procedure

| | As | Sb | Pb | Ag | Mg |
|---|---|---|---|---|---|
| Leaching solution | 24.92 | 0.35 | 0.86 | 0.05 | — |
| (g/L) | | | | | |
| Complex arsenate | 38.34 | <0.1 | <0.1 | <0.1 | 11.24 |
| Metallic arsenic (%) | 99.89 | <0.01 | <0.01 | <0.01 | <0.01 |

Further, the obtained 99.89% metallic arsenic was placed into a vacuum tank, argon gas was introduced into the vacuum tank through a gas inlet to eliminate air, the vacuum tank was heated to 620° C. to form arsenic steam, and then, hydrogen gas was introduced from the gas inlet to form mixed gas. A gas outlet was connected with a quartz reaction pipeline, and the arsenic steam was condensed at an inner wall of the quartz pipeline to form higher-purity metallic arsenic with the purity of 5 N.

### Comparative Example 6

5 kg of lead anode slime was taken to perform oxidative alkaline leaching. In the leaching process, a proper amount of hydrogen peroxide was added to be used as an oxidizing agent, a liquid-solid ratio was controlled to be 10:1, a dosage of sodium carbonate and a dosage of sodium hydroxide were respectively 0.5 mol/L, a temperature was 60° C., a leaching time was 2 h, and a stirring speed was 500 rpm. After the leaching was completed, solid-liquid separation was performed to obtain an arsenic-containing alkaline leaching solution. An arsenic leaching rate was 74.52%.

### Comparative Example 7

An alkaline leaching solution was prepared according to experiment parameters in Embodiment 2. In a process of preparing the mixed ammonium magnesium reagent, a mixing proportion of the mass of the soluble organic matter to the total mass of magnesium chloride and ammonium chloride was 0.5 mg/g, and other conditions were the same as those in Embodiment 2. Reaction parameters of a reduction roasting process of complex arsenate were the same as those in Embodiment 2. Finally, the purity of a metallic arsenic product was 98.38%, and a content of impurity antimony was 0.02%.

### Comparative Example 8

An alkaline leaching solution was prepared according to experiment parameters in Embodiment 2. In a process of preparing a hydrophobic organic matter, a temperature of hot water was 50° C., and other conditions were the same as those in Embodiment 2. Reaction parameters of a reduction roasting process of complex arsenate were the same as those in Embodiment 2. Finally, the purity of a metallic arsenic product was 97.18%, and a content of impurity antimony was 0.15%.

### Comparative Example 9

An alkaline leaching solution was prepared according to experiment parameters in Embodiment 2. In a process of preparing the mixed ammonium magnesium reagent, magnesium chloride and ammonium chloride were mixed according to n(Mg/N)=2.0, and other conditions were the same as those in Embodiment 2. Reaction parameters of a reduction roasting process of complex arsenate were the same as those in Embodiment 2. Finally, the purity of a metallic arsenic product was 96.33%, and contents of impurities such as lead, antimony and silver were all higher than 0.02%.

### Embodiment 3

5 kg of copper smelting dust (specific components were Pb: 24.95%, Cu: 14.21%, As: 5.78%, Bi: 2.50% and Zn: 2.335%, As mainly existed in mixed sulfate) was taken to perform oxidative alkaline leaching. In the leaching process, a proper amount of hydrogen peroxide was added to be used as an oxidizing agent, a liquid-solid ratio was controlled to be 5:1, a dosage of sodium carbonate was 1.5 mol/L, a dosage of sodium hydroxide was 0.5 mol/L, a temperature was 50° C., a leaching time was 1 h, and a stirring speed was 600 rpm. After the leaching was completed, solid-liquid separation was performed to obtain an arsenic-containing alkaline leaching solution. The main components were as shown in Table 2. An arsenic leaching rate was 82.38%.

After magnesium sulfate and ammonium sulfate were mixed according to a mole ratio of n(Mg/N)=0.5, sodium polyacrylate and the mixed reagent were mixed according to a mass ratio of 6 mg/g to prepare a mixed ammonium magnesium reagent. Chitosan and 100° C. hot water were mixed according to 20 mL/g, ultrasonic treatment was performed for 50 min, and sufficient dispersion was performed. The mixed ammonium magnesium reagent and the chitosan solution were sequentially added into the alkaline leaching solution according to n(Mg/As)=2.5:1 and a concentration of 5 g/L, and sufficient stirring was performed at a temperature of 50° C. and a speed of 600 rpm for 2 h, filtration was performed after the reaction was completed, and complex arsenate crystals cladded with an organic matter were obtained.

The complex arsenate crystals were roasted for 3 h at a high temperature of 300° C., then the roasted slag and carbon powder were uniformly mixed (the mass of the carbon powder was 10% of the mass of the roasted slag), and were then placed into a tube furnace to be heated to 1000° C. in a nitrogen gas atmosphere and maintained for 2.5 h. A metallic arsenic product was recycled at a condensing pipe section. Through detection, the purity of a metallic arsenic reached 99.38%, and contents of impurities such as copper, lead and zinc were all lower than 0.01%

TABLE 3
Chemical components of product in each work procedure

| | As | Cu | Pb | Zn | Mg |
|---|---|---|---|---|---|
| Leaching solution | 9.12 | 0.12 | 0.16 | 0.16 | — |
| (g/L) | | | | | |
| Complex arsenate | 35.78 | <0.1 | <0.1 | <0.1 | 11.24 |
| Metallic arsenic (%) | 99.38 | <0.01 | <0.01 | <0.01 | <0.01 |

The metallic arsenic was placed into a vacuum tank, argon gas was introduced into the vacuum tank through a gas inlet to eliminate air, the vacuum tank was heated to 650° C. to form arsenic steam, and then, hydrogen gas was introduced from the gas inlet to form mixed gas. A gas outlet was connected with a quartz reaction pipeline, and the arsenic steam was condensed at an inner wall of the quartz pipeline to form high-purity arsenic with the purity of 7 N.

### Comparative Example 10

5 kg of copper smelting dust was taken to perform oxidative alkaline leaching. In the leaching process, a proper amount of hydrogen peroxide was added to be used as an oxidizing agent, a liquid-solid ratio was controlled to be 2:1, a dosage of sodium carbonate was 1.5 mol/L, a dosage of sodium hydroxide was 0.5 mol/L, a temperature was 50° C., a leaching time was 1 h, and a stirring speed was 600 rpm. After the leaching was completed, solid-liquid separation was performed to obtain an arsenic-containing alkaline leaching solution. An arsenic leaching rate was 61.37%.

### Comparative Example 11

An alkaline leaching solution and a mixed ammonium magnesium reagent were prepared according to experiment parameters in Embodiment 3. During preparation of complex arsenate, the mixed ammonium magnesium reagent was added according to n(Mg/As)=1:1, other conditions were the same as those in Embodiment 3. Finally, the arsenic removal rate in the alkaline leaching solution was 71.69%, an arsenic grade in the complex arsenate was 28.38%, and the purity of metallic arsenic reached 98.94%

### Comparative Example 12

An alkaline leaching solution and complex arsenate were prepared according to experiment parameters in Embodiment 3. During reduction roasting, the roasting temperature was 600° C., other conditions were the same as those in Embodiment 3, and a metallic arsenic product cannot be collected finally.

### Comparative Example 13

An alkaline leaching solution and complex arsenate were prepared according to experiment parameters in Embodiment 3. During reduction roasting, when the roasted slag was mixed with the carbon powder, the mass of the carbon powder was 5% of the mass of the roasted slag, other conditions were the same as those in Embodiment 3, and a metallic arsenic product cannot be collected finally.

What is claimed is:

1. A method for preparing a high-purity metallic arsenic from an arsenic-containing solid waste through a short flow process, comprising the following steps:
1) performing an oxidative alkaline leaching on a nonferrous metallurgy arsenic-containing solid waste to obtain an arsenic-containing alkaline leaching solution;
2) sequentially adding a mixed ammonium magnesium reagent consisting of a carboxyl and/or hydroxy-containing water-soluble macromolecular organic matter, a magnesium compound, and an ammonium compound, and a hydrophobic macromolecular organic matter having a periodic geometric structure into the arsenic-containing alkaline leaching solution, and taking a reaction under a stirring to obtain complex arsenate crystals cladded with an organic matter; and
3) roasting the complex arsenate crystals cladded with the organic matter, then mixing the roasted complex arsenate crystals cladded with the organic matter with a carbon powder, performing a reduction roasting, and recycling the high-purity metallic arsenic from a smoke through a condensation.

2. The method for preparing the high-purity metallic arsenic from the arsenic-containing solid waste through the short flow process according to claim 1, wherein the nonferrous metallurgy arsenic-containing solid waste comprises at least one of an arsenic alkali slag, a copper smelting dust, and a lead anode slime.

3. The method for preparing the high-purity metallic arsenic from the arsenic-containing solid waste through the short flow process according to claim 1, wherein the oxidative alkaline leaching is performed under the following conditions: hydrogen peroxide and/or ozone are/is used as an oxidizing agent, sodium hydroxide and/or sodium carbonate are/is used as an alkaline leaching medium, a leaching temperature is 50 to 90° C., a stirring speed is 200 to 700 rpm, and a leaching time is 1 to 3 h; the nonferrous metallurgy arsenic-containing solid waste is ground until a particle size is smaller than or equal to 1 mm;
a concentration of the alkaline leaching medium is 0 to 4 mol/L; and a liquid-solid ratio is 4 to 10 mL/g.

4. The method for preparing the high-purity metallic arsenic from the arsenic-containing solid waste through the short flow process according to claim 1, wherein in the mixed ammonium magnesium reagent, a mole ratio of the magnesium compound to the ammonium compound is n(Mg/N)=0.2-1.0, and a ratio of a mass of the carboxyl and/or hydroxy-containing water-soluble macromolecular organic matter to a total mass of the magnesium compound and the ammonium compound is 1 to 10 mg/g.

5. The method for preparing the high-purity metallic arsenic from the arsenic-containing solid waste through the short flow process according to claim 1, wherein the carboxyl and/or hydroxy-containing water-soluble macromolecular organic matter is sodium polyacrylate and/or polyethylene glycol.

6. The method for preparing the high-purity metallic arsenic from the arsenic-containing solid waste through the short flow process according to claim 1, wherein
the magnesium compound is at least one of magnesium oxide, magnesium chloride, and magnesium sulfate; and
the ammonium compound is at least one of ammonium hydrogen carbonate, ammonium chloride, and ammonium sulfate.

7. The method for preparing the high-purity metallic arsenic from the arsenic-containing solid waste through the short flow process according to claim 1, wherein an adding concentration of the hydrophobic macromolecular organic matter having the periodic geometric structure in the arsenic-containing alkaline leaching solution is 1 to 5 g/L; and an adding amount of the mixed ammonium magnesium reagent in the arsenic-containing alkaline leaching solution is metered by a mole ratio of magnesium to arsenic of n(Mg/As)=1.2-2.5.

8. The method for preparing the high-purity metallic arsenic from the arsenic-containing solid waste through the short flow process according to claim 1, wherein the hydrophobic macromolecular organic matter having the periodic geometric structure is polyvinyl alcohol and/or chitosan.

9. The method for preparing the high-purity metallic arsenic from the arsenic-containing solid waste through the short flow process according to claim 1, wherein the reaction under the stirring is taken under the following conditions: a temperature is 30 to 50° C., a stirring speed is 300 to 500 rpm, and a time is 1 to 3 h.

10. The method for preparing the high-purity metallic arsenic from the arsenic-containing solid waste through the short flow process according to claim 1, wherein
the roasting is performed under the following conditions: a temperature is 200 to 300° C., and a first time is 2 to 3 h; and
the reduction roasting is performed under the following conditions: in an inert atmosphere, a roasting temperature is 800 to 1200° C., and a second time is 2 to 4 h; and a dosage of the carbon powder is 10% to 15% of a mass of a roasted slag.

11. The method for preparing the high-purity metallic arsenic from the arsenic-containing solid waste through the short flow process according to claim 4, wherein the carboxyl and/or hydroxy-containing water-soluble macromolecular organic matter is sodium polyacrylate and/or polyethylene glycol.

12. The method for preparing the high-purity metallic arsenic from the arsenic-containing solid waste through the short flow process according to claim 7, wherein the hydrophobic macromolecular organic matter having the periodic geometric structure is polyvinyl alcohol and/or chitosan.
